(19) United States
(12) Patent Application Publication
(10) Pub. No.: US 2002/0199025 A1
(43) Pub. Date: Dec. 26, 2002

(54) System and method to create an application and to manipulate application components within the application

(75) Inventors: Ali Kutay, Palo Alto, CA (US); Cihan Akin, Redwood City, CA (US); Erhan Akin, Foster City, CA (US); Hakan Akin, San Mateo, CA (US); Eliahu Albek, San Francisco, CA (US); John Gilbert, Belmont, CA (US); Paul Stremel, Moss Beach, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: AltoWeb, Inc.

(21) Appl. No.: 10/082,519

(22) Filed: Feb. 22, 2002

Related U.S. Application Data
(60) Provisional application No. 60/270,837, filed on Feb. 23, 2001.

(51) Int. Cl. G06F 15/16; G09G 5/00

(52) U.S. Cl. 709/250; 709/203; 345/763

(57) ABSTRACT

A system and method to create an application and to manipulate application components within the application are described. A user interface area is presented to display an application layout of the application, the application layout including multiple application icons and one or more connections that connect the application icons, each application icon corresponding to an application component of the application. According to one embodiment, insertion of each application icon in the application layout is facilitated and, responsive to the insertion, dynamic linking of the application icons using the one or more connections is facilitated. According to another embodiment, visual modification of the application layout is subsequently facilitated.

### REALTED APPLICATIONS

The present application claims the benefit of U.S. Provisional Patent Application Serial No. 60/270,837, filed on Feb. 23,2001 and entitled “SYSTEM AND METHOD FOR ACCESSING, ORGANIZING, PRESENTING, AND VIEWING DATA.”

### FIELD OF THE INVENTION

The present invention relates generally to data representation and, more particularly, to a system and method to create an application and to manipulate application components within the application.

### BACKGROUND

The movement toward development, deployment, and maintenance of Internet, and especially World Wide Web (Web), based applications, such as, for example, J2EE-compliant enterprise applications, represents one of the most significant recent trends in the corporate Information Technology (IT) environment. However, the deployment and maintenance of such applications require tools and technology that are complex and skill sets that are rare.

Typically, web applications have a different lifecycle than most other applications. Most applications are delivered when finished, but a web application continues to change, as new market requirements are understood. As a result, projects are fraught with certain risk, due to the myriad of moving pieces having no methodology to hold them together.

Under technological pressure and facing a lack of resources, IT organizations decide to outsource the development of web applications. However, as the applications evolve, such reliance on third parties for development and maintenance may slow down progress, as each new third party learns what the previous group has accomplished, thereby impeding the necessary quick response time.

What is needed is a single, integrated, development and runtime platform for web applications that streamlines the development, deployment, monitoring, and management of such applications, while improving productivity and quality, and, at the same time, significantly reducing associated costs.

### SUMMARY

A system and method to create an application and to manipulate application components within the application are described. A user interface area is presented to display an application layout of the application, the application layout including multiple application icons and one or more connections that connect the application icons, each application icon corresponding to an application component of the application. According to one embodiment, insertion of each application icon in the application layout is facilitated and, responsive to the insertion, dynamic linking of the application icons using the one or more connections is facilitated. According to another embodiment, visual modification of the application layout is subsequently facilitated.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a conventional network architecture.

FIG. 2 is a block diagram of one embodiment of the network including a system to create an application and to manipulate application components.

FIG. 3 is a block diagram of a conventional computer system.

FIG. 4A is a block diagram of an application architecture.

FIG. 4B is a block diagram of one embodiment for a user interface module.

FIG. 5 is a block diagram of one embodiment for a process within the application.

FIG. 6 illustrates one embodiment of a user interface to define the application 400 within the system.

FIG. 7 illustrates one embodiment of an Application Manager window area within the user interface.

FIG. 8 illustrates one embodiment of a user interface area to display an application layout of a selected application.

FIG. 9 illustrates an alternate embodiment of a user interface area to display an application layout of a selected application.

FIG. 10 illustrates an interactive window area within the user interface area to display a scaled rendering of the application layout.

FIG. 11 illustrates a block diagram of an application layout displayed within the user interface area.

FIG. 12 illustrates an exemplary user interface and an exemplary user interface area to add a new application.

FIG. 13 illustrates an exemplary builder menu within the user interface area to add application icons to the application layout of the newly added application.

FIG. 14 illustrates an exemplary user interface area containing newly added application icons.

FIG. 15 illustrates an exemplary user interface area containing application icons corresponding to renamed application components.

FIG. 16 illustrates an exemplary user interface area containing application icons and multiple connections, which dynamically link the application icons in the application layout.

FIG. 17 illustrates an exemplary editor within the user interface area to define and configure the application components.

FIG. 18A illustrates an exemplary process window area within the user interface area to define a process associated with an action application component.

FIG. 18B illustrates an exemplary scaled process window area within the user interface area to display a scaled rendering of the process.

FIG. 19 illustrates an exemplary interactive text window area within the user interface area to edit the process.

FIG. 20 illustrates an exemplary user interface area containing a button to allow the user to select a region of the application layout for further processing.

FIG. 21 illustrates another exemplary user interface area to allow the user to select a region of the application layout for further processing.

FIG. 22 illustrates an exemplary user interface area to allow the user to store the region of the application layout in a destination file.

FIG. 23 illustrates an exemplary save dialog window area within the user interface area to save the application layout in a destination file.

FIG. 24 illustrates a flow diagram of one embodiment of a method to create an application and to manipulate application components within the application.

### DETAILED DESCRIPTION

According to embodiments described herein, a system and method to create an application and to manipulate application components within the application are described. A user interface area is presented to display an application layout of the application, the application layout including multiple application icons and one or more connections that connect the application icons, each application icon corresponding to an application component of the application. According to one embodiment, insertion of each application icon in the application layout is facilitated and, responsive to the insertion, dynamic linking of the application icons using the one or more connections is facilitated. According to another embodiment, visual modification of the application layout is subsequently facilitated.

In the following detailed description of embodiments of the invention, reference is made to the accompanying drawings in which like references indicate similar elements, and in which are shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

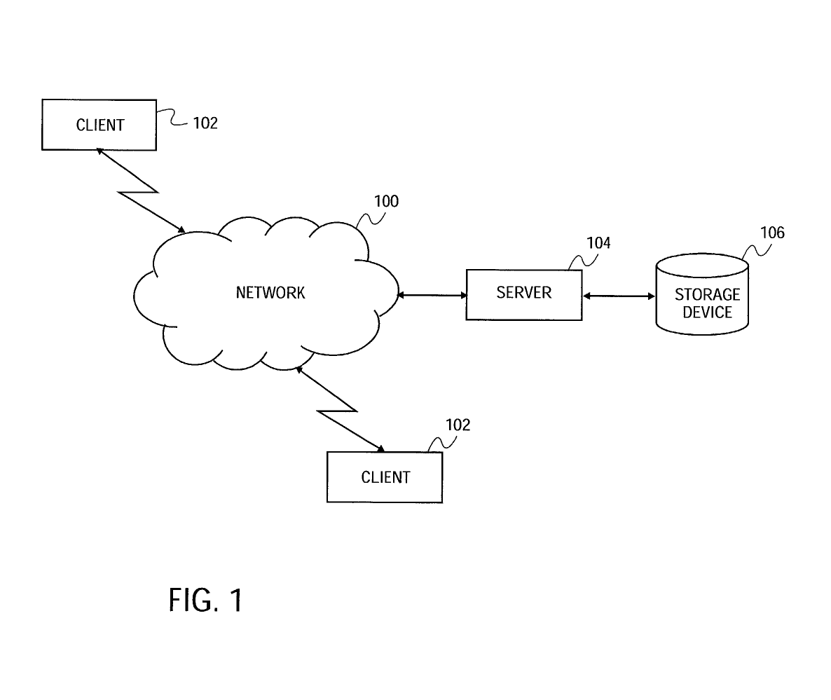

FIG. 1 is a block diagram of a conventional network architecture. Referring to FIG. 1, the block diagram illustrates the network environment in which the present invention operates. In this conventional network architecture, a server computer system 104 is coupled to a network 100, for example a wide-area network (WAN). Wide-area network 100 includes the Internet, specifically the World Wide Web, or other proprietary networks, such as America Online™, CompuServe™, Microsoft Network™, and/or Prodigy™, each of which are well known to those of ordinary skill in the art. Wide-area network 100 may also include conventional network backbones, long-haul telephone lines, Internet service providers, various levels of network routers, and other conventional means for routing data between computers. Using conventional network protocols, server 104 may communicate through wide-area network 100 to a plurality of client computer systems 102, possibly connected through wide-area network 100 in various ways or directly connected to server 104. For example, as shown in FIG. 1, clients 102 are connected directly to wide-area network 100 through direct or dial-up telephone or other network transmission line. Alternatively, clients 102 may be connected to wide-area network 100 through a conventional modem pool (not shown).

Using one of a variety of network connection devices, server computer 104 can also communicate directly with a client 102. In a particular implementation of this network configuration, a server computer 104 may operate as a web server if the World Wide Web (Web) portion of the Internet is used as wide-area network 100. Using the Hyper Text Transfer Protocol (HTTP) and the Hyper Text Markup Language (HTML) across a network, web server 104 may communicate across the Web with client 102. In this configuration, client 102 uses a client application program known as a web browser, such as the Netscape Navigator™ browser, published by America Online™, the Internet Explorer™ browser, published by Microsoft Corporation of Redmond, Wash., the user interface of America Online™, or the web browser or HTML translator of any other supplier. Using such conventional browsers and the Web, client 102 may access graphical and textual data or video, audio, or tactile data provided by server 104. Conventional means exist by which client 102 may supply information to web server 104 through the network 100 and the web server 104 may return processed data to client 102.

Server 104 is further connected to storage device 106. Storage device 106 may be any suitable storage medium, for example read only memory (ROM), random access memory (RAM), EPROMs, EEPROMs, magneto-optical discs, or any other type of medium suitable for storing electronic data.

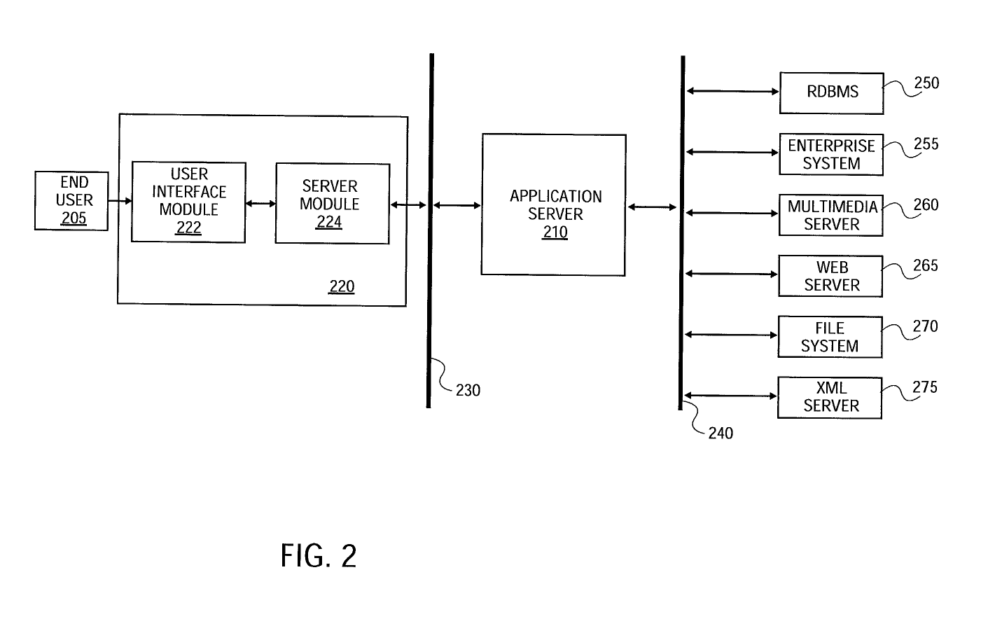

FIG. 2 is a block diagram of one embodiment for the network including a system to create an application and to manipulate application components. As illustrated in FIG. 2, in one embodiment, application server 210 is connected to one or more clients 220 via bus 230. Alternatively, server 210 may be connected to clients 220 via WAN 100. Client 220 further includes a user interface module 222 coupled to a server module 224. In another alternate embodiment, several application servers 210 may be connected to one or more clients 220 via bus 230 or via WAN 100.

End users, for example end user 205, interact with client 220 via user interface module 222. In one embodiment, end user 205 interacts with the user interface module 222 within client 220 through a browser (not shown) and WAN 100. Alternatively, end user 205 may interact with user interface module 222 directly or through any connection of a number of known types of connections.

In one embodiment, server 210 is also connected to several data sources via bus 240. Alternatively, server 210 may be connected to the data sources via WAN 100. The data sources may include for example a relational database module (RDBMS) 250, an enterprise system 255, a multimedia server 260, a web server 265, a file system 270, and/or an XML server 275. Alternatively, server 210 may be connected to any of a variety of additional data sources. In one embodiment, the data sources reside in storage device 106. Alternatively, the data sources may reside on disparate storage mediums.

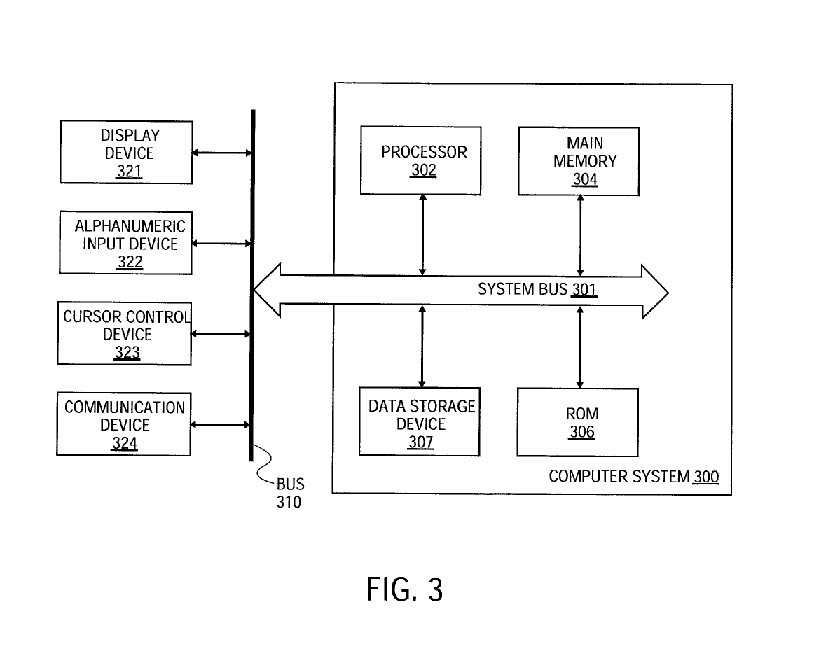

Having briefly described one embodiment of the network environment in which the present invention operates, FIG. 3 shows an exemplary block diagram of a conventional computer system 300 illustrating an exemplary client 102 or server 104 computer system in which the features of the present invention may be implemented.

Computer system 300 includes a system bus 301, or other communications module similar to the system bus, for communicating information, and a processing module, such as processor 302, coupled to bus 301 for processing information. Computer system 300 further includes a main memory 304, such as a random access memory (RAM) or other dynamic storage device, coupled to bus 301, for storing information and instructions to be executed by processor 302. Main memory 304 may also be used for storing temporary variables or other intermediate information during execution of instructions by processor 302.

Computer system 300 also comprises a read only memory (ROM) 306, and/or other similar static storage device, coupled to bus 301, for storing static information and instructions for processor 302.

In one embodiment, an optional data storage device 307, such as a magnetic disk or optical disk, and its corresponding drive, may also be coupled to computer system 300 for storing information and instructions. System bus 301 is coupled to an external bus 310, which connects computer system 300 to other devices. In one embodiment, computer system 300 can be coupled via bus 310 to a display device 321, such as a cathode ray tube (CRT) or a liquid crystal display (LCD), for displaying information to a computer user. For example, graphical or textual information may be presented to the user on display device 321. Typically, an alphanumeric input device 322, such as a keyboard including alphanumeric and other keys, is coupled to bus 310 for communicating information and/or command selections to processor 302. Another type of user input device is cursor control device 323, such as a conventional mouse, touch mouse, trackball, or other type of cursor direction keys, for communicating direction information and command selection to processor 302 and for controlling cursor movement on display 321. In one embodiment, computer system 300 may optionally include video, camera, speakers, sound card, and many other similar conventional options.

Alternatively, the client 102 can be implemented as a network computer or thin client device, such as the WebTV Networks™ Internet terminal or the Oracle™ NC. Client 102 may also be a laptop or palm-top computing device, such as the Palm Pilot™. Such a network computer or thin client device does not necessarily include all of the devices and features of the above-described exemplary computer system. However, the functionality of the present invention may nevertheless be implemented with such devices.

A communication device 324 is also coupled to bus 310 for accessing remote computers or servers, such as server 104, or other servers via the Internet, for example. The communication device 324 may include a modem, a network interface card, or other well-known interface devices, such as those used for interfacing with Ethernet, Token-ring, or other types of networks. In any event, in this manner, the computer system 300 may be coupled to a number of servers 104 via a conventional network infrastructure such as the infrastructure illustrated in FIG. 1 and described above.

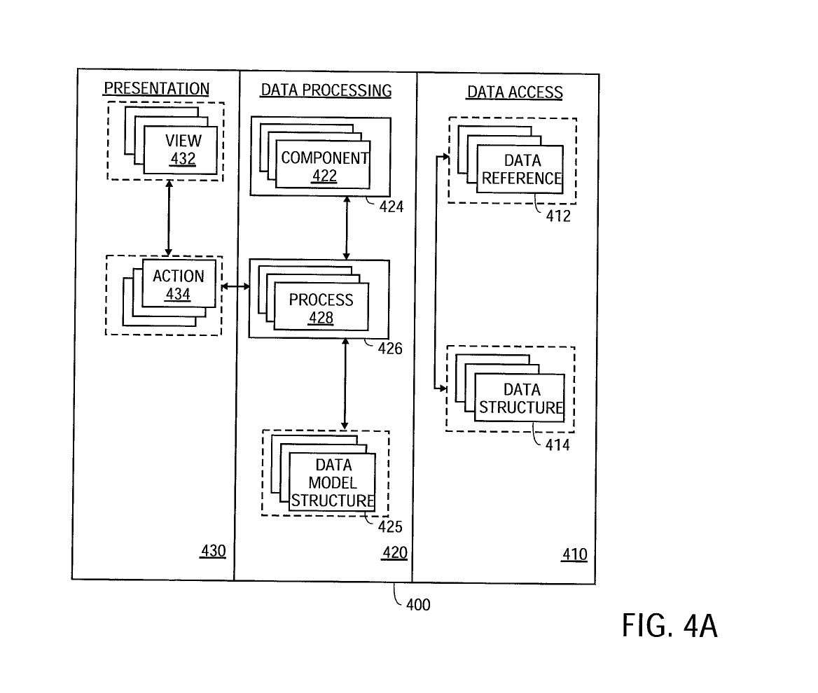

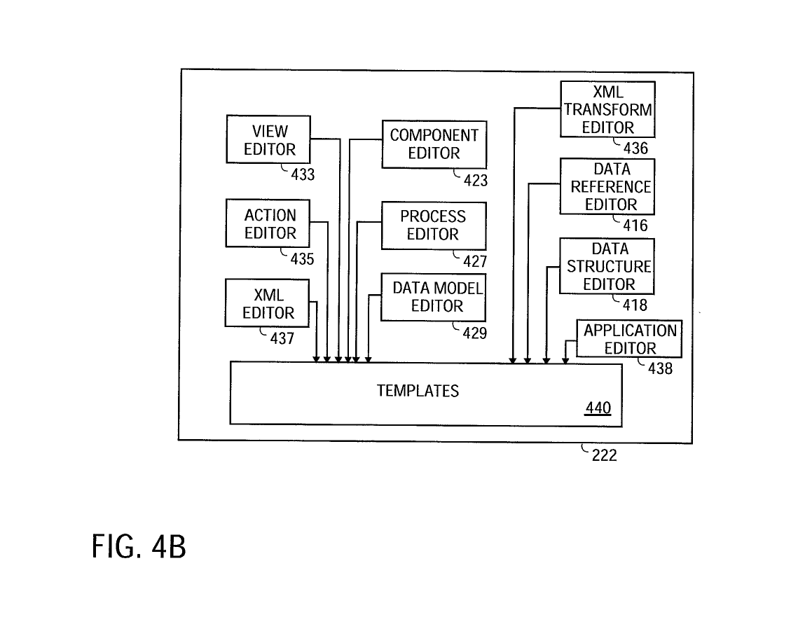

FIG. 4A is a block diagram of an application architecture. As illustrated in FIG. 4A, in one embodiment, application 400 includes a data access layer 410 configured to access and extract data from one or more data sources 250-275, shown in FIG. 2, a data processing layer 420 coupled to the data access layer 410 and configured to process and manipulate data, and a presentation layer 430 coupled to the data processing layer 420 and configured to interact with the processed data and to present one or more views of the processed data to an end user 205.

The data access layer 410 includes multiple data reference structures 412 which define ways to locate and connect to data within the data sources 250-275, and multiple data structures 414, which are typically based on the data reference structures 412.

In one embodiment, each data reference structure 412 is an object that specifies the source connection information to data. For example, one data reference structure 412 may be defined to access a relational database located locally or on a remote server, such as RDBMS 250 shown in FIG. 2. Alternatively, other data reference structures 412 may be a flat file, a web file, or an XML document, designed to connect to file system 270, web server 265, or XML server 275, respectively. A user 205 may define one or more data reference structures 412 using a data reference editor residing within the user interface module 222.

In one embodiment, each data structure 414 is an object, which refers to one or more data reference structures 412 and which includes metadata that defines the data to be accessed, specifies a set of operations to be performed on the data, and defines logic to be applied when data is retrieved from the accessed data source. Alternatively, some data structures 414, labeled abstract data structures, may be created without a reference to a data reference structure. In one embodiment, the set of operations specified are SQL operations and include operations to query, insert, update, and delete data.

A user 205 may create data structures 414 using a data structure editor residing within the user interface module 222. Once created, each data structure 414 is reusable and may be used by different users 205 to extract data from the data sources 250-275.

Referring back to FIG. 4A, data processing layer 420 includes multiple components 422 stored in one or more libraries 424. Each component 422 is a reusable logic object that performs a specific task within the data processing layer 420, for example iterations, control flow, counter, and SQL operations, such as query, insert, update, delete. Each component 422 may be stored and accessed through libraries 424, which are dynamically recompiled and reloaded at runtime. A user 205 may create components 422 using a component editor residing within the user interface module 222.

Data processing layer 420 further includes one or more processes 428 stored in a processing module 426. Each process 428 uses predetermined sets of components 422, linked together to process data retrieved from data sources 250-275.

Each process 428 is defined by the corresponding set of components 422, and by a data model structure 425, which defines and stores pieces of data read and written by the process 428. A user 205 may define processes 428 using a process editor residing within the user interface module 222. Processes 428 will be described in further detail below.

In one embodiment, data model structure 425 is visible only to its corresponding process 428 and includes properties that define each data item retrieved from data sources 250-275, for example Input, Output, In-Out, or Static, optionality, and whether each data item is secure or not. Alternatively, each data model structure 425 may be transparent and, as a result, accessible to all processes 428 defined within the processing module 426. In one embodiment, data model structures 425 may be nested and may form a nested structure.

Referring back to FIG. 4A, presentation layer 430 includes multiple views 432 which allow users 205 to view processed data. In one embodiment, views 432 are Java Server Page ASP) views. Each JSP view 432 is a dynamic page, for example an HTML page, which supports event-based input mechanisms and contains special tags interpretable by the server 210. Alternatively, views 432 may be presented in eXtensible Markup Language (XML). In one embodiment, each XML view 432 is an XML document accessible to users 205 via Universal Resource Locators (URLs).

Each view 432 includes a mechanism for triggering an action 434 and sets of data transmitted from the data model structures 425 and formatted for the type of view, for example in JSP or XML formats. In one embodiment, actions 434 reside within presentation layer 430 and provide a linkage between users 205 and processes 428. Each action 434 is coupled to one or more views 432 that can trigger that action. Also, each action 434 is further coupled to a process 428 triggered by the action and to a set of views 434 that must be activated after the process 428 concludes.

FIG. 4B is a block diagram of one embodiment for a user interface module. As illustrated in FIG. 4B, the user interface module 222 includes a data reference editor 416 to define one or more data reference structures 412 within the data access layer 410 of the application 400 and a data structure editor 418 to create one or more data structures 414 within the data access layer 410.

User interface module 222 further includes a component editor 423 to create sets of components 422 within the data processing layer 420 of the application 400 and a process editor 427 to define and run processes 428 within the data processing layer 420. A data model editor is further provided within the user interface module 222 to define data model structures 425 for processes 428.

User interface module 222 further includes a view editor 433 to create one or more views 432 within the presentation layer 430 of the application 400 and an action editor 435 to define actions 434 within the presentation layer 430. In one embodiment, an XML editor 437 is provided within user interface module 222 to create views 432 presented in XML format and an XML transform editor 436 is further provided to convert documents created in a source format from a source Document Type Definition (DTD), for example XML, to a target DTD, for example HTML, and to present the document to users in the target format defined by the target DTD.

User interface module 222 further includes an application editor 438 to enable user 205 to create visually an application and to manipulate application components of the application in an application layout displayed for the user 205, as described in further detail below.

In one embodiment, user interface module 222 further includes templates 440. The editors within user interface module 222 use templates 440 to create or define corresponding structures for the application 400.

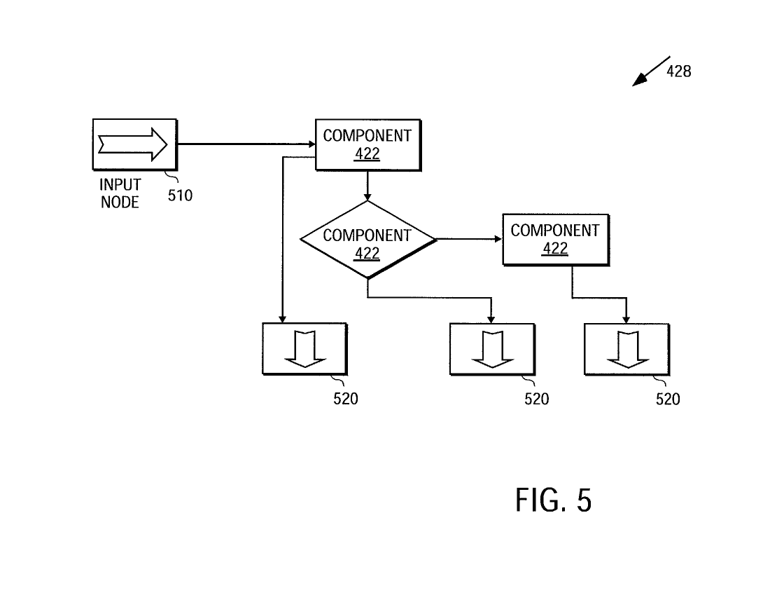

FIG. 5 is a block diagram of one embodiment for a process within the application 400. As illustrated in FIG. 5, in one embodiment, a process 428 includes an input node or process request 510, which receives multiple input parameters from user 205 through one or more views 432. Input node 510 is coupled to one or more components 422, which contain the logic of the process 428 and perform specific logic tasks. Each component 422 has a single point of entry and produces a set of responses 520. Each response 520 represents a result of process 428 and is returned to an action 434 that invoked the process 428. In one embodiment, the action 434 that triggered the process 428 associates each response 520 to a view 432 to be transmitted back to user 205.

Processes 428 can be linked by mapping a response 520 of one process 428 to an input node 510 of another process 428. Processes 428 may also be nested, wherein one process 428 may operate within another process 428.

One or more data model structures 425 are defined for each process 428. The input parameters received at the input node 510 and output parameters within responses 520 are mapped to the data model structures 425 to provide data persistence for the duration of the execution of the process 428.

In one embodiment, components 422 are standard for each process 428. For example, condition components provide binary decision processing, process data components define operations to be performed on data sources, and iteration components provide data fetching and simplify the configuration of process 428. Alternatively, components 422 may be custom created for each process 428 by defining the corresponding data model structures 425 and the set of responses 520.

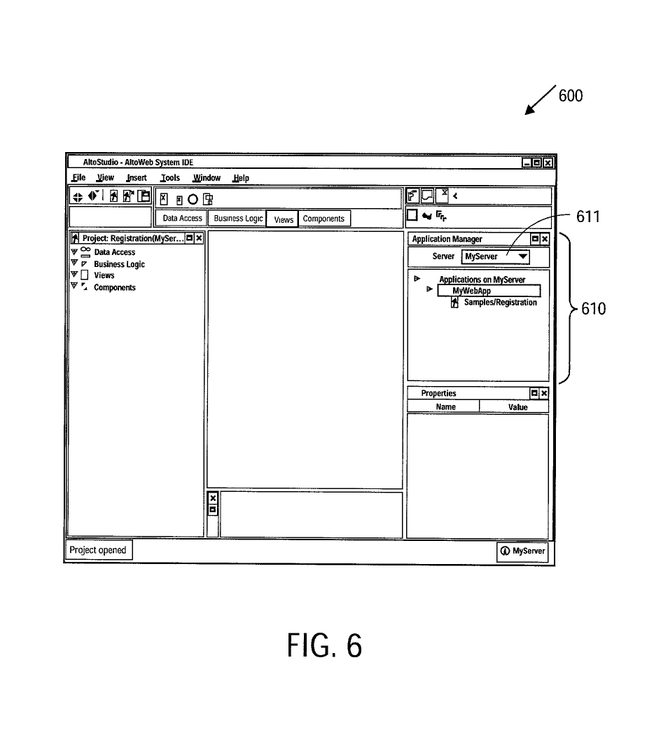

FIG. 6 illustrates one embodiment of a user interface to define the application 400 within the system. In one embodiment, user 205 defines the application through the user interface module 222 within client 220.

As illustrated in FIG. 6, in one embodiment, interface 600 includes an Application Manager window area 610, which displays applications defined within client 220 as nodes of a hierarchical tree structure. The applications are associated with the application server 210 or with multiple servers similar to server 210. The application server 210 is selected through a MyServer pull-down menu 611 located within the Application Manager window area 610.

The Application Manager window area 610 allows the user 205 to manage the defined applications using conventional mouse commands. In one embodiment, user 205 selects an application MyWebApp within the hierarchical tree structure displayed in window area 610 using a mouse left-click command. Once the selected application is highlighted within the tree structure, user 205 can open a menu associated with the selected application using a mouse right-click command, as described in further detail below.

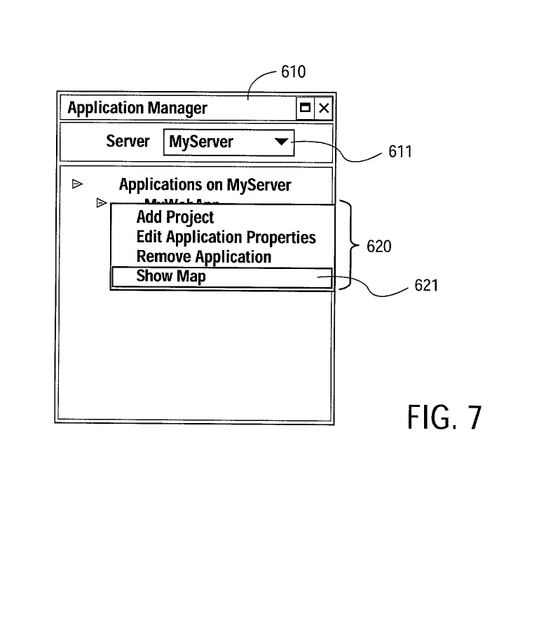

FIG. 7 illustrates one embodiment of the Application Manager window area 610 within the interface 600. As illustrated in FIG. 7, in one embodiment, subsequent to the mouse right-click command on the highlighted application MyWebApp 400, a menu 620 opens within the Application Manager window area 610, the menu 620 being associated with the selected application.

The menu 620 enables the user 205 to perform certain operations on the selected application, for example, to edit properties of the selected application, to remove the selected application from the selected server, or to access and display an application layout of the selected application in a separate user interface area. In one embodiment, the user 205 selects a ShowMap field 621 within the menu 620 using a mouse left-click command to display the application layout of the selected application.

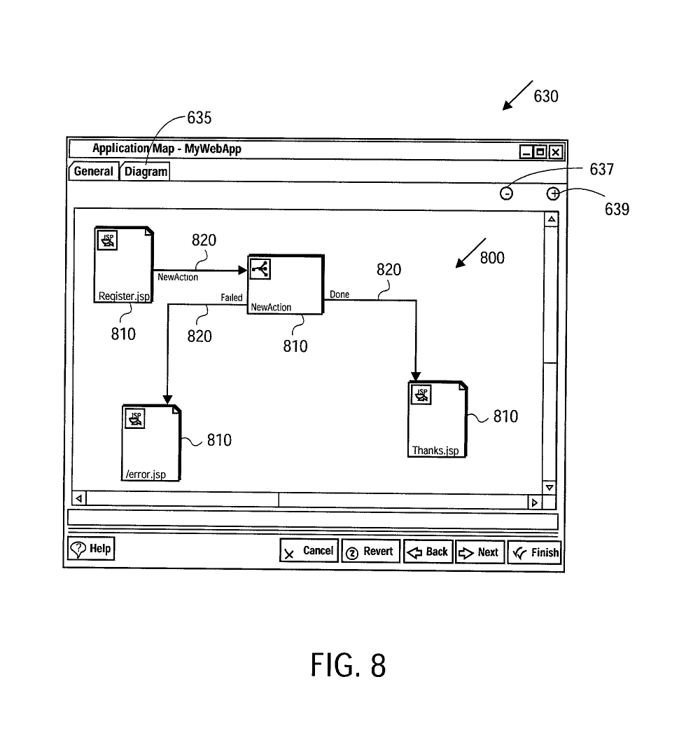

FIG. 8 illustrates one embodiment of a user interface area to display an application layout of a selected application. As illustrated in FIG. 8, in one embodiment, subsequent to the selection of the ShowMap field 621 within the menu 620, user 205 accesses the application editor 438, which presents a user interface area 630 to the user 205. In order to access the application layout of the selected application, user 205 selects a Diagram tab 635 within the user interface area 630. Subsequent to the selection of the Diagram tab 635, the application editor 438 displays application layout 800 in the user interface area 630. In one embodiment, application layout 800 includes multiple application icons 810 interconnected through multiple connections 820, each application icon 810 corresponding to an application component of the selected application, for example, a business logic component or process 428, an action component 434, a view component 432, or a data structure component 414.

On the initial access, the application editor 438 computes the positions of each application icon 810 and each connection 820 in order to initiate the application layout 800. In one embodiment, the user interface area 630 enables the user 205 to visually modify the application layout 800 using conventional mouse click commands. For example, the user interface area 630 enables the user 205 to select an application icon 810 using a mouse left-click command. The application editor 438 facilitates the selection of the icon 810 within the user interface area 630. As a result, the selected application icon 810 and all connections 820 to the icon 810 are redisplayed in a highlighted color within the application layout 800. At the same time, the name of the application component corresponding to the selected application icon 810 is displayed in a message field at the bottom of the user interface area 630.

Furthermore, in one embodiment, the user interface area 630 enables the user 205 to select an application icon 810 through a mouse left-click command and to modify the position of the selected application icon. 810 within the application layout 800 by dragging the selected icon 810 to a new position. The application editor 438 facilitates the selection of the icon 810 and the visual modification of its position. In addition, the application editor 438 facilitates repositioning of one or more application icons 810 connected to the selected application icon 810 within the application layout 800.

In one embodiment, the user interface area 630 enables the user 205 to select a connection 820 through a mouse left-click command and to modify the connection 820 within the application layout 800. The application editor 438 facilitates the selection of the connection 820 and its visual modification. In one embodiment, the user 205 is enabled to visually modify a type of the connection 820 through a mouse left double-click command on the connection 820. The type of the connection 820 toggles between a two-point default connection and a multi-point connection.

Alternatively, the user 205 may visually modify a position of the connection 820 by dragging the selected connection 820 to a new position within the application layout 800. Moreover, the user 205 may display the connection points of the selected connection 820 using a mouse left-click command on the connection. As a result, the connection points are drawn and displayed in the application layout 800.

Each connection point of the selected connection 820 may be visually accessed by the user 205 in the user interface area 630 through a mouse right-click command on the connection point. Subsequently, a connection point popup menu (not shown) is displayed to enable the user 205 to perform operations associated with the connection point, for example, to add/remove a connection point to/from the selected connection 820.

The user interface area 630 enables the user 205 to select a connection point of a connection 820 through a mouse left-click command and to modify the position of the selected connection point within the application layout 800 by dragging the connection point to a new position. The application editor 438 facilitates the selection of the connection point and the visual modification of its position. In addition, the application editor 438 facilitates repositioning of one or more application icons 810 connected to the selected connection point within the application layout 800.

In one embodiment, the user interface area 630 enables the user 205 to select a destination file to store the application layout 800. The application editor 438 facilitates the visual selection of the destination file and the storage of the application layout 800 in the destination file. The application layout 800 is stored as an image file using one of many known storage formats, for example, the JPEG format. A layout popup menu (not shown) is displayed, subsequent to a mouse right-click command on the application layout 800 within the user interface area 630, to allow the user 205 to select the destination file and to save the image of the application layout 800. The image file will reflect the current scale of the application layout 800 and current selections within the application layout 800, such as icon, connection, or connection point selections, are reset.

In one embodiment, the user interface area 630 further includes an interactive Zoom In “−” button 637 and an interactive Zoom Out “+” button 639 to enable the user 205 to scale the application layout 800 through mouse click commands. The user 205 may decrease the size of the application layout 800 by clicking on the Zoom In button 637 or may increase the size of the application layout by a predetermined factor by clicking on the Zoom Out button 639. If an application icon 810 has been previously selected, the user 205 may center a scaled view of the application layout 800 on the selected application icon 810 by using a mouse right-drag command on the application layout 800.

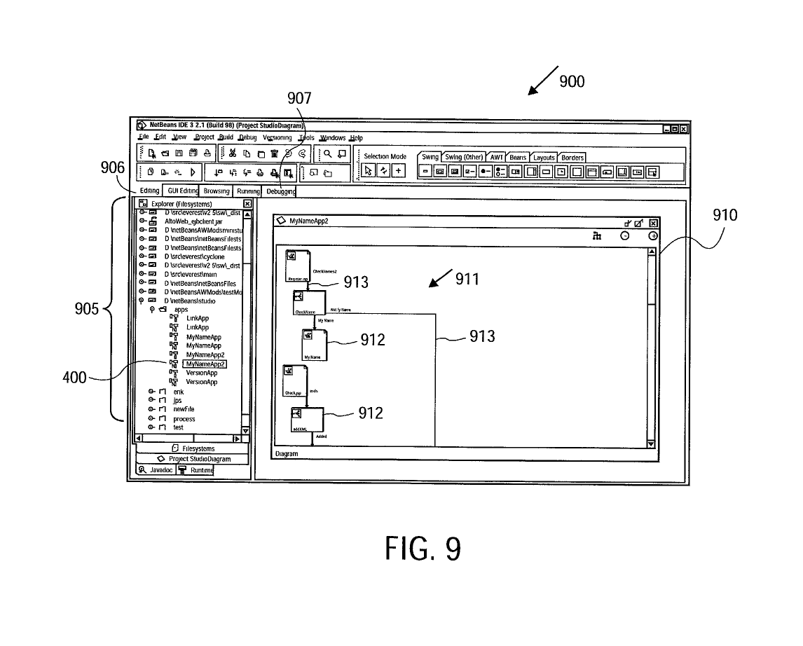

FIG. 9 illustrates an alternate embodiment of a user interface area to display an application layout of a selected application. As illustrated in FIG. 9, the user interface 900 includes an interactive file window area 905, which displays applications 400 associated with a selected server in a hierarchical tree structure. The file window area 905 enables the user 205 to select and visually access an application 400, for example MyNameApp2 in the tree structure.

The application editor 438 facilitates the display of an application layout 911 of the selected application 400 in an interactive user interface area 910 within the user interface 900. The user 205 selects an Editing tab 906 within the user interface 900 with a mouse left-click command in order to access and visually modify the displayed application layout 911. In one embodiment, as described in detail above, the application layout 911 includes multiple application icons 912 dynamically linked through multiple connections 913, each application icon 912 corresponding to an application component of the selected application 400.

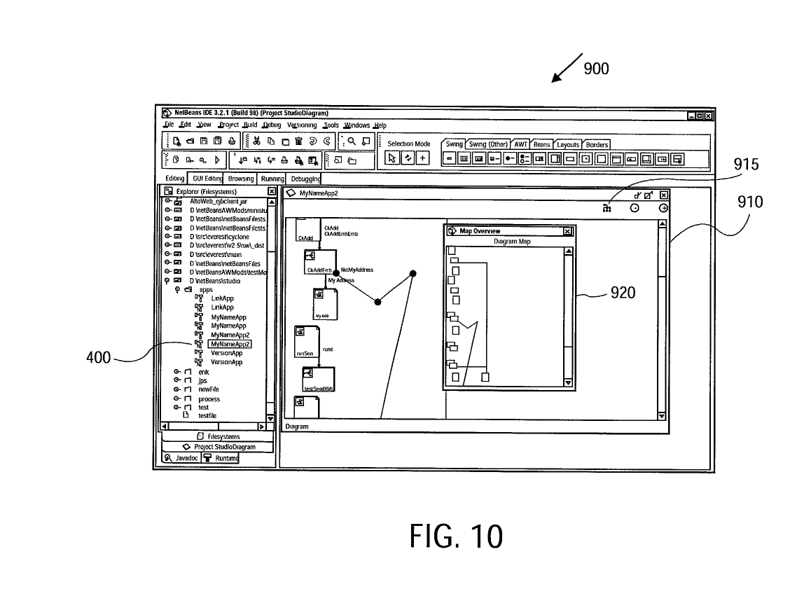

FIG. 10 illustrates an interactive window area within the user interface area 910 to display a scaled rendering of the application layout 911. As illustrated in FIG. 10, in one embodiment, the user interface area 910 enables the user 205 to select an Overview button 915 with a mouse click command. Subsequent to the selection, the application editor 438 facilitates the presentation of the interactive window area 920 to display a scaled rendering of the application layout 911. The interactive window area 920 is dynamically linked to the user interface area 910,such that any selection of an application icon 912 in one area is simultaneously reflected in the other area.

The interactive window area 920 is moveable and sizeable by the user 205 through conventional mouse commands. The scaled rendering of the application layout 911 is interactively displayed at a predetermined scale and assists the user 205 in navigation of a complex application layout 911. For example, the user 205 selects an application icon 912 within the interactive window area 920 and the application editor 438 facilitates a simultaneous selection of the selected application icon 912 in the application layout 911 within the user interface area 910, such that a scroll pane for the application layout 911 will scroll to the location of selected application icon 912.

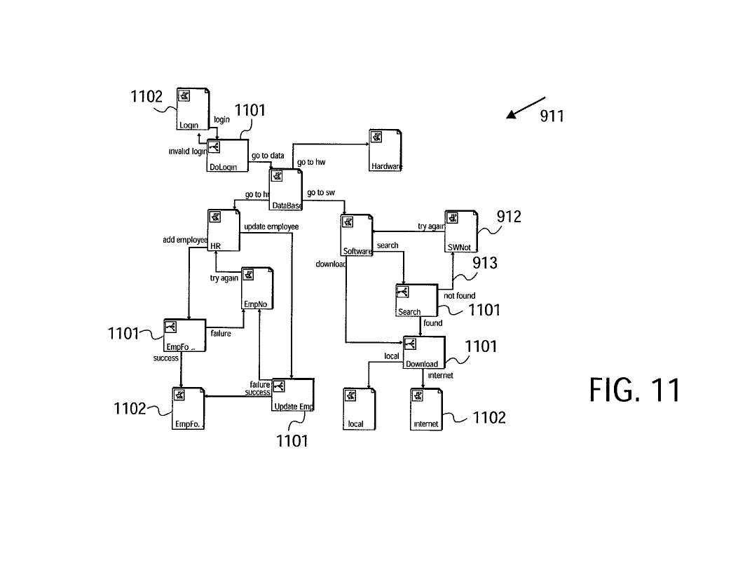

FIG. 11 illustrates a block diagram of an application layout 911 displayed within the user interface area 910. As illustrated in FIG. 11, in one embodiment, the application layout 911 includes multiple application icons 912 dynamically linked through multiple connections 913, each application icon 912 corresponding to an application component of the selected application 400.For example, application icons 912 include icons 1101 corresponding to actions 434 within the application 400 and icons 1102 corresponding to views 432 within the application 400, such as, for example, Java Server Page (JSP) views. Each application icon 912 connects to one or more adjacent application icons 912 via two-point or multi-point connections 913.

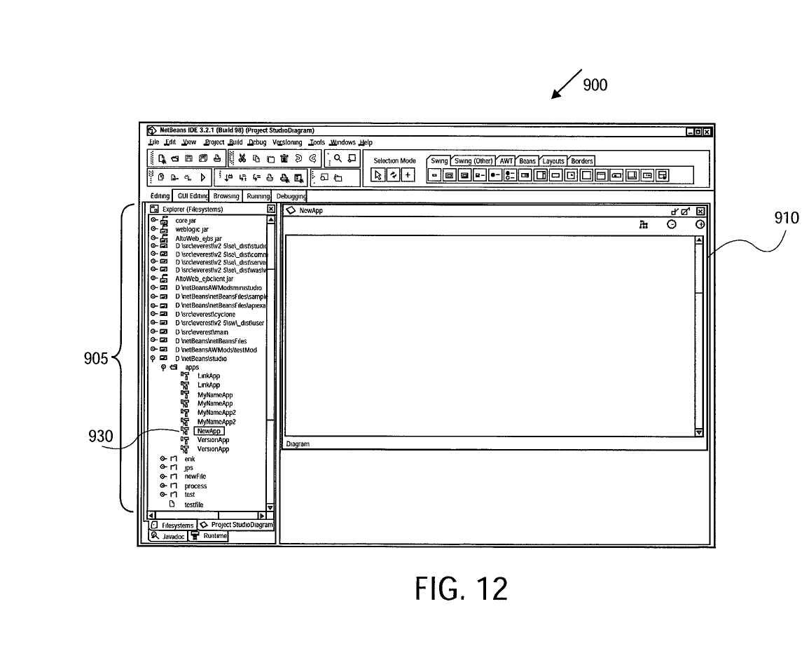

FIG. 12 illustrates an exemplary user interface 900 and an exemplary user interface area 910 to add a new application 400. As illustrated in FIG. 12, in one embodiment, user 205 adds an application 400 using a mouse right-click command and a NewApp field 930 is added to the hierarchical tree structure within the interactive file window area 905. The tree structure within the interactive file window area 905 also includes applications located on the application server 210. The application 400 is initially empty and does not have any application components. Therefore, the user interface area 910 that displays the application layout of the new application 400 is also empty.

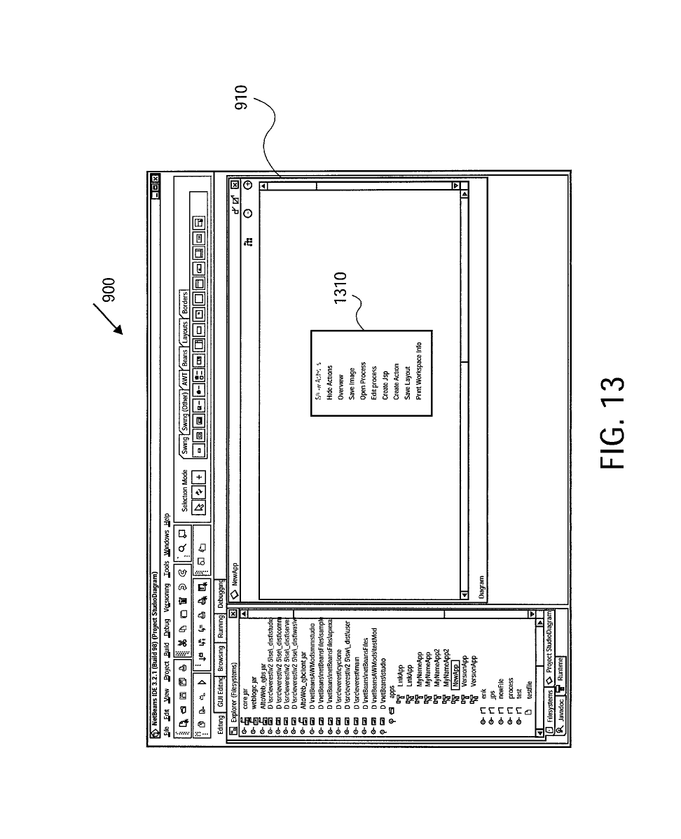

FIG. 13 illustrates an exemplary builder menu within the user interface area 910 to add application icons to the application layout of the newly added application 400. As illustrated in FIG. 13, in one embodiment, user 205 accesses a builder menu 1310 with a mouse right-click command in order to add application components to the application 400. The application editor 438 facilitates the display of the builder popup menu 1310 within the user interface area 910.

The builder menu 1310 contains multiple fields to enable the user 205 to create components, such as, for example, JSP views 432 and actions 434, to save the application layout of the new application 400, to open and edit processes 428, to display a scaled rendering of the application layout 911, to rename/remove application components, and to rename/remove connections among application icons corresponding to the application components. In one embodiment, the user 205 accesses the interactive builder menu 1310 and selects a Create JSP field to add one or more JSP view components 432 to the application 400. The application editor 438 facilitates insertion of application icons corresponding to the created JSP view components 432 into the application layout 911. Alternatively, the user 205 may select the Create Action field to add one or more action components 434 to the application 400. Similarly, the application editor 438 facilitates insertion of application icons corresponding to the action components 434 into the application layout 911.

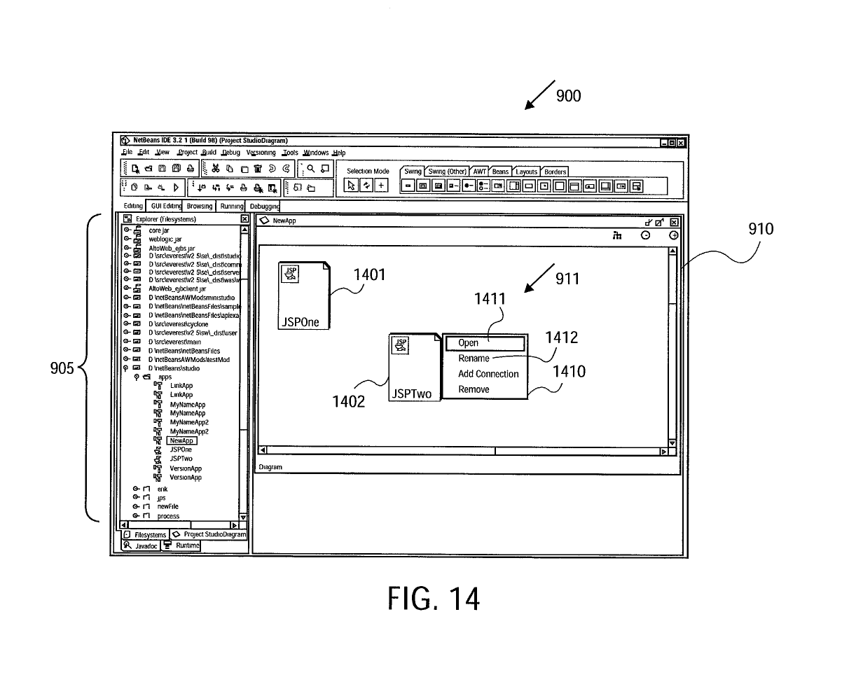

FIG. 14 illustrates an exemplary user interface area 910 containing newly added application icons 1401, 1402. As illustrated in FIG. 14, in one embodiment, subsequent to the creation of JSP view application components 432 for the application 400, application icons 1401 and 1402 are displayed in the application layout 911 within the user interface area 910. Each application icon 1401, 1402 corresponds to one JSP view component 432 and is labeled JSPOne and JSPTwo, respectively. Simultaneous to the display of the application icons 1401, 1402, the application editor 438 facilitates display of the corresponding application components JSPOne and JSPTwo in the hierarchical tree structure within the interactive file window area 905.

In one embodiment, the application editor 438 attaches a component popup menu 1410 to each application icon 1401, 1402, and facilitates the display of the component popup menu 1410 within the user interface area 910 upon receiving a mouse right-click command on the respective application icon from the user 205. The component popup menu 1410 contains multiple fields and enables the user 205 to rename the application component and its respective application icon 1401, 1402, to add a connection coupled to the respective application icon 1401, 1402, or to open a corresponding editor to facilitate the configuration of the respective application component, for example, a view editor 433 to facilitate configuration of the JSP view components 432, or an action editor 435 to facilitate configuration of the action components 434. In one embodiment, if the user 205 selects the Open field 1411 within the component popup menu 1410, the corresponding editor is opened in a separate user interface area to enable the user 205 to configure the associated application component. If the user 205 selects the Rename field 1412 within the component popup menu 1410, the application editor 438 facilitates renaming of the respective application component corresponding to the application icon 1401 or 1402 in the application layout 911.

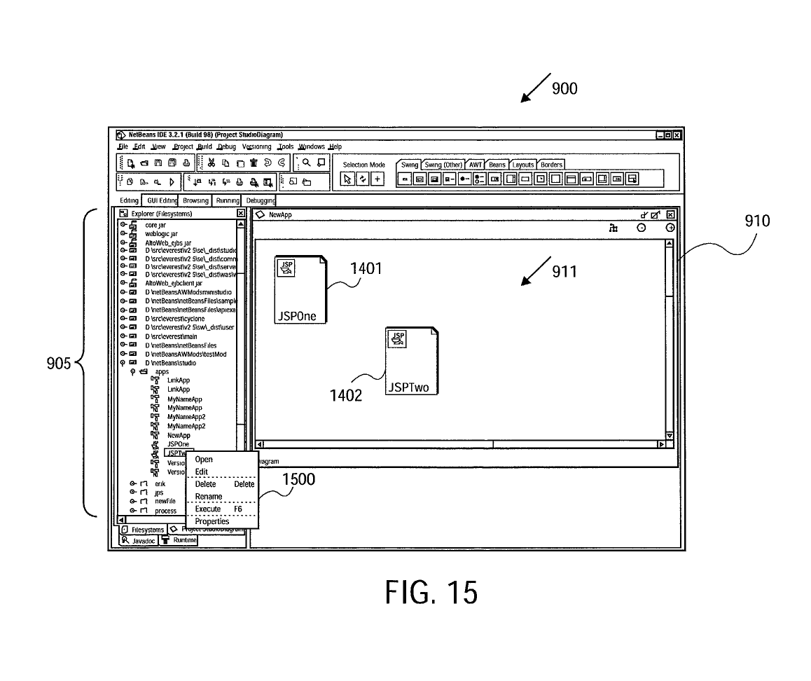

FIG. 15 illustrates an exemplary user interface area 910 containing application icons 1401, 1402 corresponding to renamed application components. As illustrated in FIG. 15, in one embodiment, subsequent to the selection of the Rename field 1412 within the component popup menu 1410, the application editor 438 facilitates the display of the application icons 1401, 1402 corresponding to the renamed application components, which are displayed as NewJSPOne and NewJSPTwo, respectively, in the application layout 911. Simultaneously, the application editor 438 facilitates insertion of the renamed application components in the tree structure within the interactive file window area 905.

In one embodiment, the user 205 may rename the application components and their respective application icons displayed within the application layout 911 through a system file popup menu 1500 using conventional mouse click commands similar to the ones described above. The application editor 438 facilitates the display of the file system popup menu 1500 upon receipt of a mouse right-click command from the user 205.

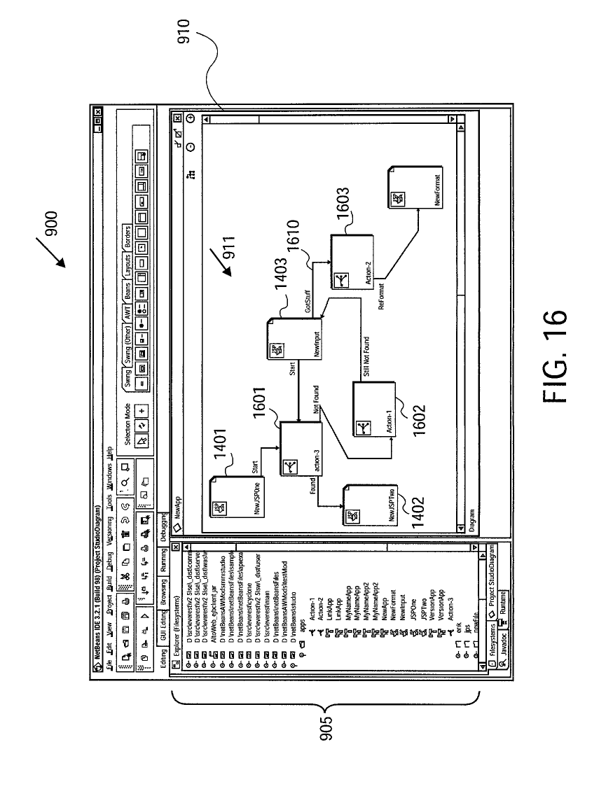

FIG. 16 illustrates an exemplary user interface area 910 containing application icons and multiple connections, which dynamically link the application icons in the application layout 911. As illustrated in FIG. 16, in one embodiment, the application editor 438 facilitates the insertion of application icons corresponding to application components created by the user 205 in the application layout 911 and, responsive to the insertion, facilitates dynamic linking of each application icon using one or more connections 1610. Among the application icons displayed in the application layout 911, application icons 1401, 1402, and 1403 correspond to a respective JSP view component 432, and application icons 1601, 1602, and 1603 correspond to a respective action component 434. The application editor 438 further facilitates insertion of the application components 432, 434 in respective positions within the tree structure within the interactive file window area 905.

In one embodiment, the user 205 may save the application layout 911 and continue the development of the application 400 at a later time. Alternatively, user 205 may continue with the configuration of each application component 432, 434 previously created and displayed as application icons 1401-1403, and 1601-1603 in the layout 911.

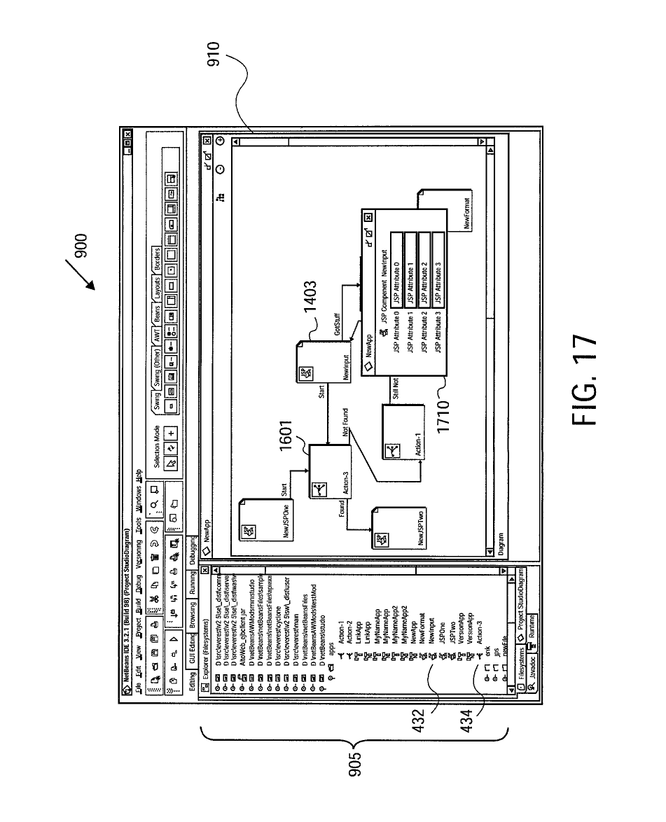

FIG. 17 illustrates an exemplary editor within the user interface area to define and configure the application components. As illustrated in FIG. 17, in one embodiment, user 205 accesses an editor corresponding to each created application component through a mouse double-click command on the application component within the interactive file window area 905. Alternatively, the user 205 may access the editor through a mouse right-click command on the application icon corresponding to the application component and selection of an Open field 1411 in the popup menu 1410.

Subsequently, the application editor 438 presents a first interactive window area 1710 containing the editor in order to enable the user 205 to define the respective application component. For example, if the user 205 double clicks on a JSP view component NewInput 432 in the file window area 905 or right clicks on the application icon 1403 corresponding to the NewInput JSP view component 432, the application editor 438 presents the first interactive window area 1710 containing the view editor 433. Similarly, if the user 205 double clicks on an action component Action-3 434 in the file window area 905 or right clicks on the application icon 1601 corresponding to the action component 434, the application editor 438 presents the first interactive window area 1710 containing the action editor 435. The user 205 can interact with the editor in the first interactive window area 1710 to define the corresponding application component. In one embodiment, the respective editor is shown docked into a new mode. Alternatively, the editor may be docked into the application mode.

In one embodiment, the user 205 accesses a process 428 that may be associated with an action component 434 of the application 400. The user 205 accesses the builder menu 1310 and selects an Open Process field to open and define the process 428, as described in further detail below.

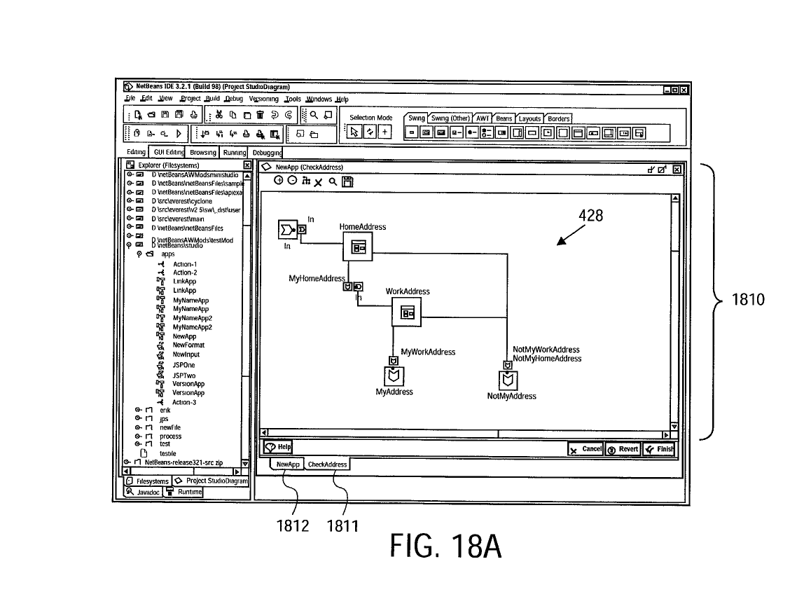

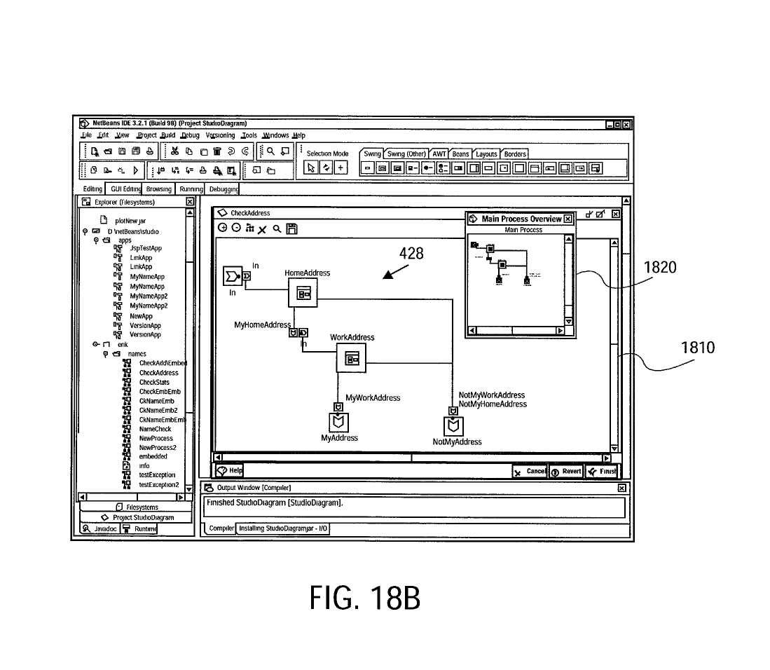

FIG. 18A illustrates an exemplary process window area within the user interface area 910 to define a process 428 associated with an action application component. As illustrated in FIG. 18A, subsequent to the selection of the Open Process field in the builder menu 1310, the application editor 438 facilitates display of the process editor 427 within a process window area 1810. In one embodiment, the process editor 427 is opened and docked into the user interface area 910. Alternatively, the process editor 427 may be opened in a separate process window area 1810.

The user 205 accesses the user interface area 910 containing the application layout 911 through a NewApp tab 1812. The user 205 accesses the process window area 1810 containing a representation of the process 428 through a Process Name (CheckAddress) tab 1811.

In one embodiment, the user 205 accesses a text editor 437 to edit the process 428. The user 205 accesses the builder menu 1310 and selects an Edit Process field to open the text editor 437.

FIG. 18B illustrates an exemplary scaled process window area within the user interface area 910 to display a scaled rendering of the process 428. As illustrated in FIG. 18B, in one embodiment, similar to the interactive window area 920 shown in FIG. 10, an interactive scaled process window area 1820 may be presented within the user interface area 910 to enable the user 205 to visualize a scaled rendering of the representation of the process 428 shown in process window area 1810. The interactive scaled process window area 1820 is dynamically linked to the process window area 1810, such that any selection of a process component of the process 428 in one area is simultaneously reflected in the other area.

The interactive scaled process window area is moveable and sizeable by the user 205 through conventional mouse commands. The scaled rendering of the process 428 is interactively displayed at a predetermined scale and assists the user 205 in navigation of the process 428.

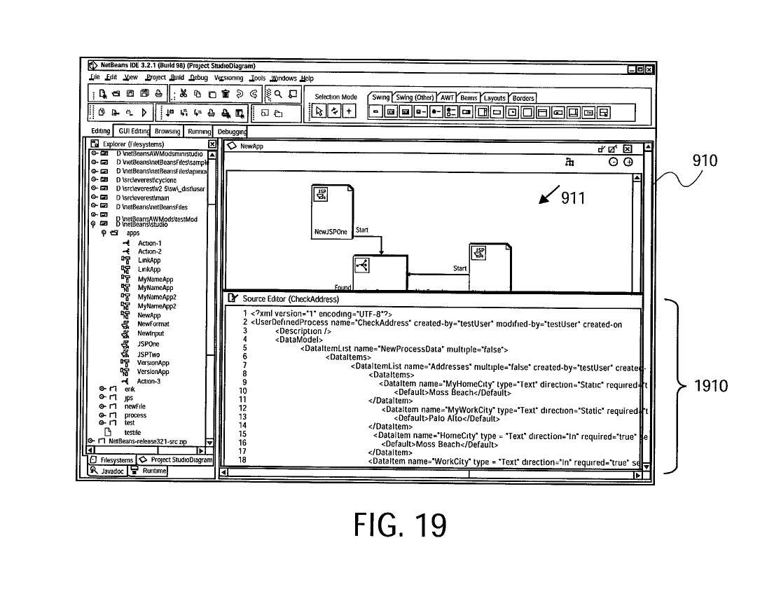

FIG. 19 illustrates an exemplary interactive text window area within the user interface area 910 to edit the process 428. As illustrated in FIG. 19, subsequent to the selection of the Edit Process field in the builder menu 1310, the application editor 438 facilitates display of the text editor 437 within a second interactive window area 1910. The application editor 438 further opens an XML file corresponding to the process 428 in the text editor 437 within the second interactive window area 1910 to enable the user 205 to edit the process 428.

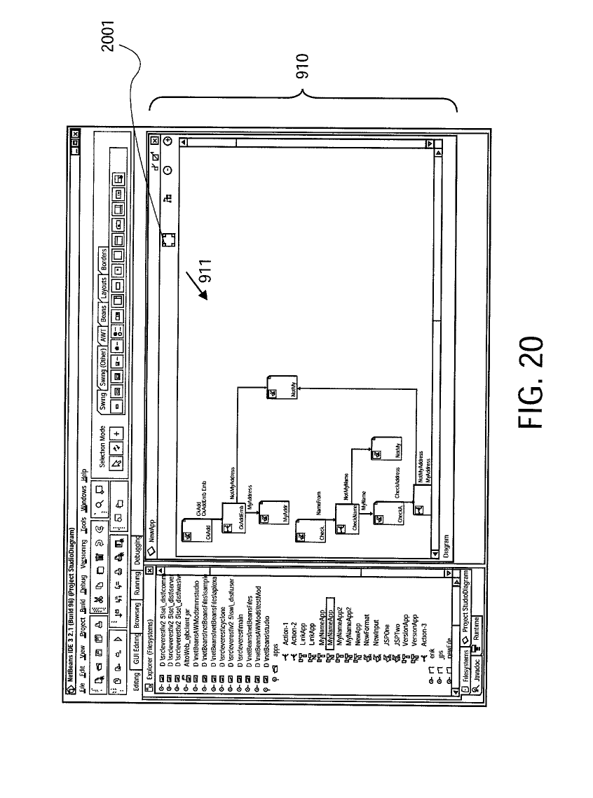

FIG. 20 illustrates an exemplary user interface area 910 containing a button to allow the user 205 to select a region of the application layout 911 for further processing. As illustrated in FIG. 20, the user interface area 910 includes a rubber band button 2001 to enable the user 205 to select a region of the application layout 911 through a mouse left-click command on the button 2001.

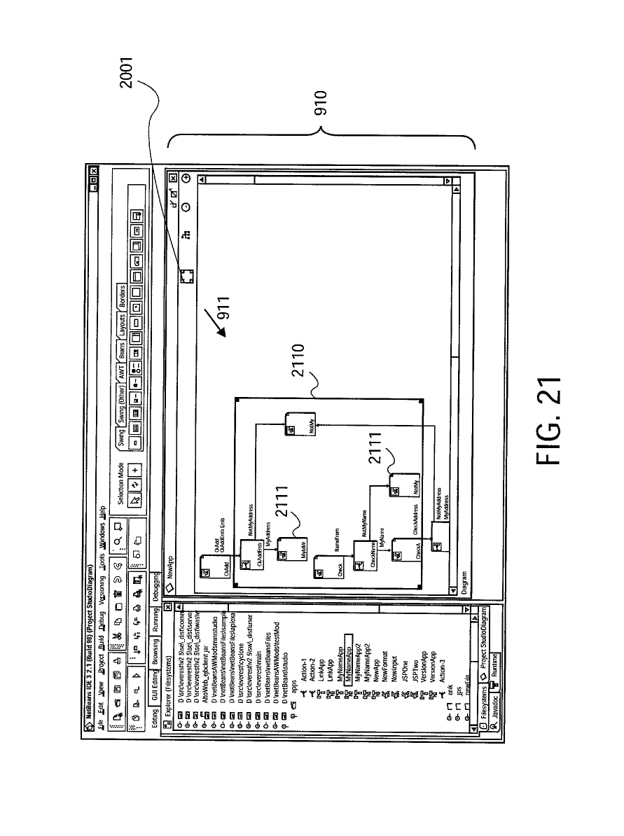

FIG. 21 illustrates another exemplary user interface area to allow the user 205 to select a region of the application layout 911 for further processing. As illustrated in FIG. 21, in one embodiment, after the user 205 left clicks on the rubber band button 2001, the cursor of the application layout 911 is replaced by a draw cursor (not shown). The user 205 can subsequently drag the draw cursor using conventional mouse commands to create a continuous rubber band perimeter 2110, which is displayed over the application layout 911 within the user interface area 910. Any application icon 2111 contained within the perimeter 2110 is considered to be selected for further processing. The user interface area 910 enables the user 205 to move or resize the rubber band perimeter 2110 with conventional mouse drag commands. The user interface area also enables the user 205 to add or remove application icons located in the region within the perimeter 2110 by dragging the application icons into or outside of the perimeter 2110.

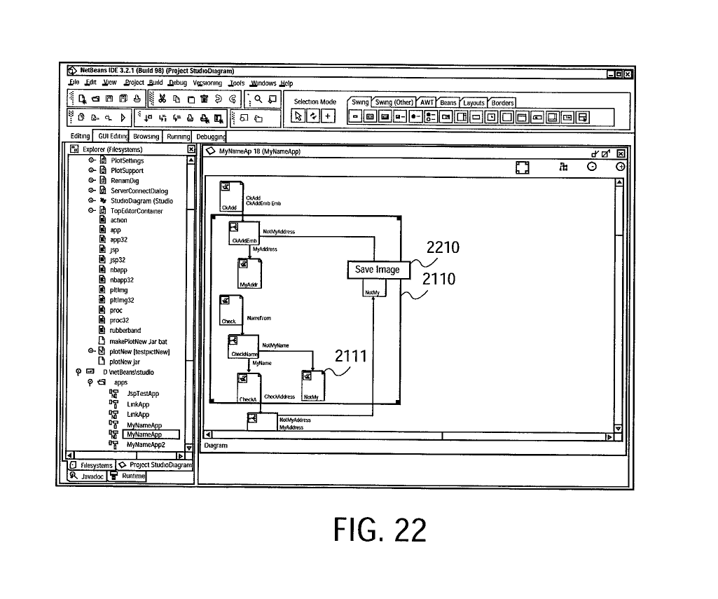

FIG. 22 illustrates an exemplary user interface area 910 to allow the user 205 to store the region of the application layout 911 in a destination file. As illustrated in FIG. 22, in one embodiment, the user 205 accesses a rubber band popup menu 2210 with a mouse right-click command on the region within the perimeter 2110. The application editor 438 facilitates display of the rubber band popup menu 2210 within the perimeter 2110 to enable the user to save the region in a destination file. The user 205 selects a Save Image field within the rubber band popup menu 2210 and further selects the destination file from a file dialog menu (not shown).

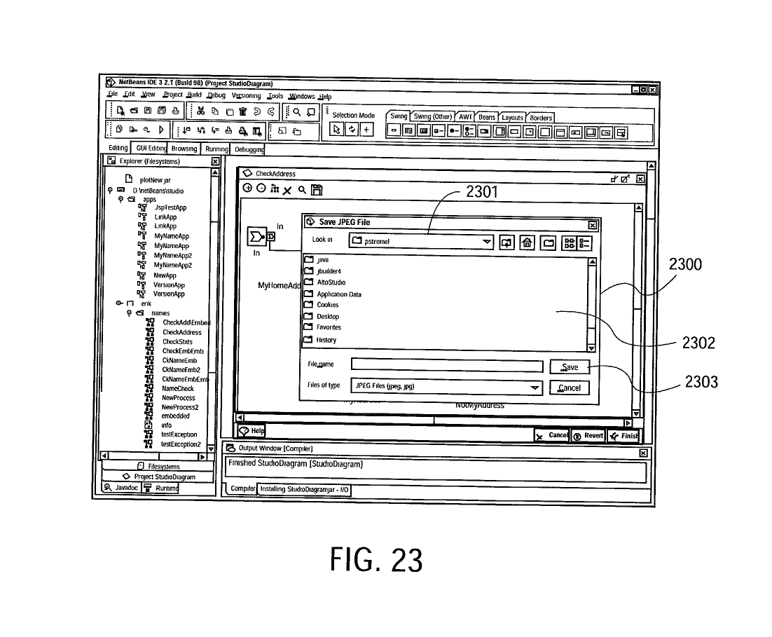

FIG. 23 illustrates an exemplary save dialog window area within the user interface area to save the application layout in a destination file. As illustrated in FIG. 23, in one embodiment, the user 205 can save an image of the application layout 911 of an image of the process 428 for further processing. The user 205 accesses a layout popup menu (not shown) using a mouse right-click command on the respective background of the application layout 911 or the process 428. A Save Image field within the layout popup menu enables the user 205 to access a save dialog window area 2300 to select a destination file to store the image of the application layout 911 or the process 428.

In one embodiment, the application editor 438 facilitates the visual selection of the destination file and the storage of the application layout 911 in the destination file. The application layout 911 is stored as an image file using one of many known storage formats, for example, the JPEG format. The user 205 selects the destination file in the file popup menu 2301 and in the file window area 2302, and further selects a Save tab 2303 with a mouse left-click command to store the application layout 911. The saved image file will reflect the current scale of the application layout 911.

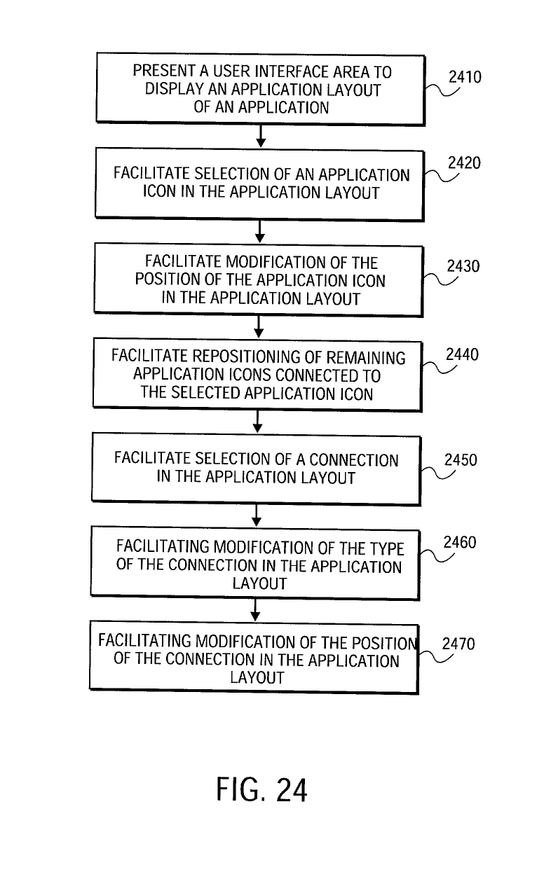

FIG. 24 illustrates a flow diagram of one embodiment of a method to create an application and to manipulate application components within the application. As illustrated in FIG. 24, at processing block 2410, a user interface area is presented to display an application layout of an application.

At processing block 2420, selection of an application icon in the application layout is facilitated. At processing block 2430, modification of the position of the application icon in the application layout is facilitated. At processing block 2440, repositioning of remaining application icons connected to the selected application icon is facilitated.

At processing block 2450, selection of a connection in the application layout is facilitated. At processing block 2460, modification of the type of connection is facilitated in the application layout. Finally, at processing block 2470, modification of the position of the connection is facilitated in the application layout.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method to facilitate visual representation of an application to provide data to a user, said method comprising:
presenting a user interface area to display an application layout of said application, said application layout comprising a plurality of application icons and at least one connection that connects said plurality of application icons, each application icon corresponding to an application component of said application.

2. The method according to claim 1, further comprising:
facilitating visual modification of said application layout.

3. The method according to claim 2, wherein said facilitating further comprises:
facilitating selection of an application icon of said plurality of application icons; and
facilitating modification of a position of said application icon within said application layout.

4. The method according to claim 3, wherein facilitating said selection further comprises:
facilitating display of said application icon in a highlighted color within said application layout.

5. The method according to claim 3, wherein facilitating said modification of said position further comprises:
facilitating repositioning of at least one remaining application icon of said plurality of application icons connected to said application icon via said at least one connection.

6. The method according to claim 2, wherein said facilitating further comprises:
facilitating selection of a connection of said at least one connection; and
facilitating modification of said connection within said application layout.

7. The method according to claim 6, wherein facilitating said modification of said connection further comprises:
facilitating visual modification of a type of said connection.

8. The method according to claim 7, wherein said type defines a two-point connection.

9. The method according to claim 7, wherein said type defines a multi-point connection.

10. The method according to claim 6, wherein facilitating said modification of said connection further comprises:
facilitating visual modification of a position of said connection between adjacent application icons within said application layout.

11. The method according to claim 1, further comprising:
facilitating selection of a destination file to store said application layout; and
facilitating storage of said application layout in said destination file.

12. The method according to claim 1, further comprising:
facilitating display of a scaled rendering of said application layout in an interactive window area adjacent to said user interface area.

13. The method according to claim 12, further comprising:
facilitating selection of a n application icon of said plurality of application icons in said interactive window area; and
responsive to said selection, facilitating selection of said application icon in said application layout within said user interface area.

14. The method according to claim 1, further comprising:
facilitating insertion of each application icon of said plurality of application icons in said application layout; and
responsive to said insertion, facilitating dynamic linking of said each application icon using said at least one connection.

15. The method according to claim 14, wherein facilitating said insertion further comprises:
facilitating renaming of said application component corresponding to said each application icon in said application layout.

16. The method according to claim 14, further comprising:
presenting a first interactive window area to enable said user to define said application component; and
presenting a second interactive window area to enable said user to insert text related to said application component in a predetermined language.

17. The method according to claim 14, wherein said application component is an application business logic component.

18. The method according to claim 14, wherein said application component is a data source component.

19. The method according to claim 14, wherein said application component is a presentation logic component.

20. A system to facilitate visual representation of an application to provide data to a user, said system comprising:
means for presenting a user interface area to display an application layout of said application, said application layout comprising a plurality of application icons and at least one connection that connects said plurality of application icons, each application icon corresponding to an application component of said application.

21. The system according to claim 20, further comprising:
means for facilitating visual modification of said application layout.

22. The system according to claim 21, further comprising:
means for facilitating selection of an application icon of said plurality of application icons; and
means for facilitating modification of a position of said application icon within said application layout.

23. The system according to claim 22, further comprising:
means for facilitating display of said application icon in a highlighted color within said application layout.

24. The system according to claim 22, further comprising:
means for facilitating repositioning of at least one remaining application icon of said plurality of application icons connected to said application icon via said at least one connection.

25. The system according to claim 21, further comprising:
means for facilitating selection of a connection of said at least one connection; and
means for facilitating modification of said connection within said application layout.

26. The system according to claim 25, further comprising:
means for facilitating visual modification of a type of said connection.

27. The system according to claim 26, wherein said type defines a two-point connection.

28. The system according to claim 26, wherein said type defines a multi-point connection.

29. The system according to claim 25, further comprising:
means for facilitating visual modification of a position of said connection between adjacent application icons within said application layout.

30. The system according to claim 20, further comprising:
means for facilitating selection of a destination file to store said application layout; and
means for facilitating storage of said application layout in said destination file.

31. The system according to claim 20, further comprising:
means for facilitating display of a scaled rendering of said application layout in an interactive window area adjacent to said user interface area.

32. The system according to claim 31, further comprising:
means for facilitating selection of an application icon of said plurality of application icons in said interactive window area; and
responsive to said selection, means for facilitating selection of said application icon in said application layout within said user interface area.

33. The system according to claim 20, further comprising:
means for facilitating insertion of each application icon of said plurality of application icons in said application layout; and
responsive to said insertion, means for facilitating dynamic linking of said each application icon using said at least one connection.

34. The system according to claim 33, further comprising:
means for facilitating renaming of said application component corresponding to said each application icon in said application layout.

35. The system according to claim 33, further comprising:
means for presenting a first interactive window area to enable said user to define said application component; and
means for presenting a second interactive window area to enable said user to insert text related to said application component in a predetermined language.

36. The system according to claim 33, wherein said application component is an application business logic component.

37. The system according to claim 33, wherein said application component is a data source component.

38. The system according to claim 33, wherein said application component is a presentation logic component.

39. A computer readable medium containing executable instructions, which, when executed in a processing system, cause said processing system to perform a method comprising:
presenting a user interface area to display an application layout of said application, said application layout comprising a plurality of application icons and at least one connection among said plurality of application icons, each application icon corresponding to an application component of said application.

40. The computer readable medium according to claim 39, wherein said method further comprises:
facilitating visual modification of said application layout.

41. The computer readable medium according to claim 40, wherein said facilitating further comprises:
facilitating selection of an application icon of said plurality of application icons; and
facilitating modification of a position of said application icon within said application layout.

42. The computer readable medium according to claim 41, wherein facilitating said selection further comprises:
facilitating display of said application icon in a highlighted color within said application layout.

43. The computer readable medium according to claim 41, wherein facilitating said modification of said position further comprises:
facilitating repositioning of at least one remaining application icon of said plurality of application icons connected to said application icon via said at least one connection.

44. The computer readable medium according to claim 40, wherein said facilitating further comprises:
facilitating selection of a connection of said at least one connection; and
facilitating modification of said connection within said application layout.

45. The computer readable medium according to claim 44, wherein facilitating said modification of said connection further comprises:
facilitating visual modification of a type of said connection.

46. The computer readable medium according to claim 45, wherein said type defines a two-point connection.

47. The computer readable medium according to claim 45, wherein said type defines a multi-point connection.

48. The computer readable medium according to claim 44, wherein facilitating said modification of said connection further comprises:
facilitating visual modification of a position of said connection between adjacent application icons within said application layout.

49. The computer readable medium according to claim 39, wherein said method further comprises:
facilitating selection of a destination file to store said application layout; and
facilitating storage of said application layout in said destination file.

50. The computer readable medium according to claim 39, wherein said method further comprises:
facilitating display of a scaled rendering of said application layout in an interactive window area adjacent to said user interface area.

51. The computer readable medium according to claim 50, wherein said method further comprises:
facilitating selection of an application icon of said plurality of application icons in said interactive window area; and
responsive to said selection, facilitating selection of said application icon in said application layout within said user interface area.

52. The computer readable medium according to claim 39, wherein said method further comprises:
facilitating insertion of each application icon of said plurality of application icons in said application layout; and
responsive to said insertion, facilitating dynamic linking of said each application icon using said at least one connection.

53. The computer readable medium according to claim 52, wherein facilitating said insertion further comprises:
facilitating renaming of said application component corresponding to said each application icon in said application layout.

54. The computer readable medium according to claim 52, wherein said method further comprises:
presenting a first interactive window area to enable said user to define said application component; and
presenting a second interactive window area to enable said user to insert text related to said application component in a predetermined language.

55. The computer readable medium according to claim 52, wherein said application component is an application business logic component.

56. The computer readable medium according to claim 52, wherein said application component is a data source component.

57. The computer readable medium according to claim 52, wherein said application component is a presentation logic component.

58. A system to facilitate visual representation of an application to provide data to a user, said system comprising:
an application editor to present a user interface area to display an application layout of said application, said application layout comprising a plurality of application icons and at least one connection that connects said plurality of application icons, each application icon corresponding to an application component of said application.

59. The system according to claim 58, wherein said application editor facilitates visual modification of said application layout.

60. The system according to claim 59, wherein said application editor further:
facilitates selection of an application icon of said plurality of application icons; and
facilitates modification of a position of said application icon within said application layout.

61. The system according to claim 60, wherein said application editor further facilitates display of said application icon in a highlighted color within said application layout.

62. The system according to claim 60, wherein said application editor further facilitates repositioning of at least one remaining application icon of said plurality of application icons connected to said application icon via said at least one connection.

63. The system according to claim 59, wherein said application editor further:
facilitates selection of a connection of said at least one connection; and
facilitates modification of said connection within said application layout.

64. The system according to claim 63, wherein said application editor further facilitates visual modification of a type of said connection.

65. The system according to claim 64, wherein said type defines a two-point connection.

66. The system according to claim 64, wherein said type defines a multi-point connection.

67. The system according to claim 63, wherein said application editor further facilitates visual modification of a position of said connection between adjacent application icons within said application layout.

68. The system according to claim 58, wherein said application editor further:
facilitates selection of a destination file to store said application layout; and
facilitates storage of said application layout in said destination file.

69. The system according to claim 58, wherein said application editor further facilitates display of a scaled rendering of said application layout in an interactive window area adjacent to said user interface area.

70. The system according to claim 69, wherein said application editor further:
facilitates selection of an application icon of said plurality of application icons in said interactive window area; and
responsive to said selection, facilitates selection of said application icon in said application layout within said user interface area.

71. The system according to claim 58, wherein said application editor further:
facilitates insertion of each application icon of said plurality of application icons in said application layout; and
responsive to said insertion, facilitates dynamic linking of said each application icon using said at least one connection.

72. The system according to claim 71, wherein said application editor further facilitates renaming of said application component corresponding to said each application icon in said application layout.

73. The system according to claim 71, further comprising:
an application component editor coupled to said application editor to present a first interactive window area to enable said user to define said application component, and to present a second interactive window area to enable said user to insert text related to said application component in a predetermined language.
